(19) United States
(12) Patent Application Publication
(10) Pub. No.: US 2005/0144002 A1
(43) Pub. Date: Jun. 30, 2005

(54) Text-to-speech conversion with associated mood tag

(75) Inventor: Janardhanan PS, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 11/008,406

(22) Filed: Dec. 9, 2004

Related U.S. Application Data
(60) Provisional application No. 60/528,012, filed on Dec. 9, 2003.

(51) Int. Cl. G10L 13/00

(52) U.S. Cl. 704/266

(57) ABSTRACT

A method (and associated apparatus) comprises associating a mood tag with text. The mood tag specifies a mood to be applied when the text is subsequently converted to an audio signal. In accordance with another embodiment, a method (and associated apparatus) comprises receiving text having an associated mood tag and converting the text to speech in accordance with the associated mood tag.

### CROSS-REFERENCE TO A RELATED APPLICATION

The present application claims the benefit of, and incorporates by reference, provisional application Ser. No. 60/528,012, filed Dec. 9, 2003, and entitled “Voice Portal Development.”

### BACKGROUND

Machine generated speech that has human-like realism has been a long-standing problem. Frequently, the speech generated by a machine does not replicate the human voice in a satisfactory manner.

### BRIEF SUMMARY

In accordance with at least one embodiment, a method (and associated apparatus) comprises associating a mood tag with text. The mood tag specifies a mood to be applied when the text is subsequently converted to an audio signal. In accordance with another embodiment, a method (and associated apparatus) comprises receiving text having an associated mood tag and converting the text to speech in accordance with the associated mood tag.

### BRIEF DESCRIPTION OF THE DRAWINGS

For a detailed description of exemplary embodiments of the invention, reference will now be made to the accompanying drawings in which:

FIG. 1 shows a system in accordance with an exemplary embodiment of the invention;

FIG. 2 shows a method embodiment related to embedding a mood tag in a document;

FIG. 3 shows a method embodiment related to embedding mood tags in text to be converted to speech; and

FIG. 4 shows a method embodiment related to converting text with embedded mood tags to speech.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” is used in a broad sense to refer to a collection of two or more components. By way of example, the term “system” may refer to a speech conversion system, a text-to-speech converter, a computer system, a collection of computers, a subsystem of a computer, etc. The parameter “F0” refers to baseline pitch or fundamental frequency and is measured in units of Hertz. The term “prosody” refers to those aspects of speech which extend beyond a single speech sound, such as stress, accent, intonation and rhythm. Stress and accent are properties of syllables and words, while intonation and rhythm refer to changes in pitch and timing across words and utterances. When describing speech phonetically, it is usual to refer to two layers of sound: the first consists of speech sounds-vowels and consonants; the second is the prosodic layer, which refers to features occurring across speech sounds.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

A system is provided that permits a voice user interface document to be authored that includes embedded instructions in speech synthesis markup languages interpretable by a text-to-speech converter. The embedded instructions may specify a voice attribute and an age (e.g., male, age 20) to be implemented by the converter for an associated text segment of text. In accordance with an embodiment of the invention, a mood tag is associated with one or more of the text segments, also known as prompts, so that the text-to-speech converter produces a speech signal in accordance with the specified mood (e.g., angry, happy) as well as with the applicable gender and age instructions. The system uses the mood tags to access one or more rules associated with each mood that specify how a default set of speech-related parameters (e.g., prosodic parameters) is to be modified to create the specified mood.

Each mood tag defines a particular mood and may have an intensity value or argument associated therewith. The intensity value dictates the intensity level to be created for a particular mood. For example, the happy mood can comprise mildly happy, moderately, or extremely happy. In the embodiments described below, each mood has 10 different intensity levels. The intensity value associated with the happy mood tag dictates the level of happiness to be created by the text-to-speech converter.

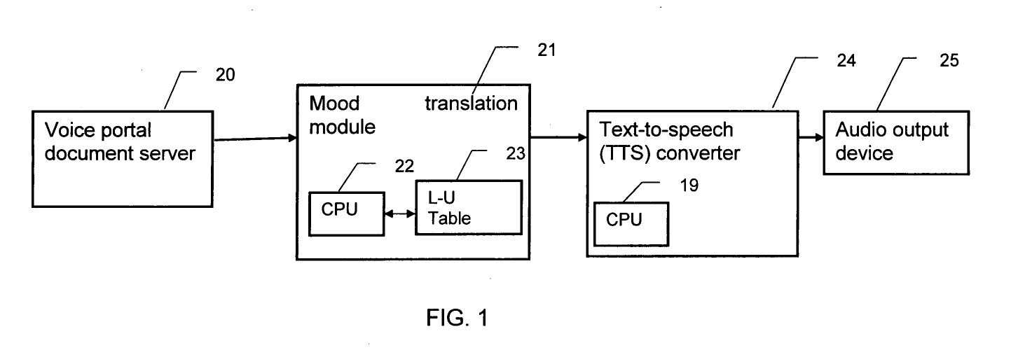

FIG. 1 shows an exemplary embodiment of a speech conversion system comprising a voice portal document server 20, a mood translation module 21, a text-to-speech (TTS) converter 24, and an audio output device 25. In general, the voice portal document server 20 provides documents containing embedded mood tags (described below) to the mood translation module 21. Each mood tag is associated with a segment of text (also referred to as a “prompt” in some embodiments) and dictates the mood with which the associated text segment is to be read by the TTS converter. The mood translation module 21 comprises a central processing unit (“CPU”) 21 running code and a look-up table 23 and converts each mood tag and its intensity into prosodic parameters for use by the TTS converter 24. The TTS converter 24 comprises a speech synthesizer and converts the text in the received documents to a speech (audio) signal embodying the specified mood to be played through the audio output device 25. The TTS converter includes a CPU 19 adapted to run code that can implement at least some of the functionality described herein. The TTS converter 24 may be implemented in accordance, for example, with the converter described in U.S. Pat. No. 6,810,378, incorporated herein by reference.

The voice portal document server 20 comprises a computer system with a voice user interface in some embodiments, but may be implemented as any one of a variety of electronic devices. The mood translation module 21 is provided by the document server 21 with one or more moods and associated intensities in conjunction with the text segments. Depending on the voice attribute (e.g., male, female) selected for a text segment, an F0 value (pitch) also is passed to the translation module 21 by the document server 20. The translation module 21 stores a set of rules for modifying a set of prosodic parameters comprising one or more of rate, volume, pitch and pitch range (intonation) for each of these moods. The prosodic parameters being modified have values that are used for a default reading tone, for example, a neutral tone that has no particular mood. The rate specifies the speaking rate as a number of words per minute, or other suitable measure of rate. Volume sets the output volume or amplitude. Pitch (F0) sets the baseline pitch in units of Hertz and comprises the fundamental frequency of the speech waveform. The parameter pitch range also refers to a pitch contour applied for the total duration of the speech output for the associated text segment. The use of these prosodic parameters will be described below in further detail.

The audio output device 25 comprises a speaker such as may be included with a computer system. Alternatively, the audio output device 25 may comprise an interface to a telephone or the telephone itself. The TTS converter 24 or the audio output device 25 may include an amplifier and other suitable audio processing circuitry.

The embodiments describe herein make use of a speech synthesis markup language, such as VoiceXML, to assist the authoring of text for the generation of synthetic speech by the TTS converter 24. Such markup languages comprise instructions to be performed by the TTS converter for the text-to-speech conversion. The TTS converter 24 relies on these instructions to produce an utterance. In the VoiceXML markup language the quality of the generated speech is controlled by the elements of emphasis, break, and prosody.

The emphasis element comprises a value that may be encoded in various different ways. For example, the emphasis element may comprise a value that indicates that the emphasis imposed by the TTS converter 24 is to be strong, moderate, none, or reduced.

The break element is used to control pausing and comprises a value that specifies the pause to be of type none, extra small, small, medium, large, or extra large.

The prosodic element comprises any one or more of the following six parameters, some of which are discussed above: pitch, contour, pitch range, rate, duration and volume. The contour parameter sets the pitch contour for the associated text. The pitch range parameter is configurable to be a value that specifies extra high, high, medium, low, extra low, or a default value. The rate parameter dictates the speaking rate as extra fast, fast, medium, slow, extra slow or a default value. The duration parameter specifies the duration of the desired time taken to read the text segment associated with the duration attribute. The volume parameter dictates the sound volume generated by the TTS converter 24 and can be set as silent, extra soft, soft, medium, loud, extra loud, or a default value. The pitch parameter specifies the F0 value (fundamental frequency) to be used for the associated text segment. One or more of these prosodic parameters are modified or otherwise configured to create desired moods for the synthetic speech. It is noted that various markup languages may use different methods for prosody control, however, the general principles of the present invention, as described in an embodiment herein, are capable of application and adaptation in such cases.

Various combinations of values for the various prosodic parameters can be used to implement different moods for the spoken text. In accordance with various embodiments of the invention, one or more mood tags can be embedded into the text to be associated with at least a portion of the text (text segment) within a speech synthesis markup language document. The text and associated mood tags are provided by the voice portal document server 20 to the mood translation module 21. By default, a particular configuration of values are applied to the various prosodic parameters. When the mood translation module 21 receives the text and associated mood tag, the module 21 determines or accesses the appropriate rules to modify the default prosodic parameters. The rules are stored in the look-up table 23 in the mood translation module 21. The translation module 21 modifies the input F0 attribute from the document server 20 and modifies one or more other prosodic parameters based on the rules from look-up table 23 defined for the particular mood. Translation module 21 passes the text and the mood-specific prosodic parameters to the TTS converter 24. The TTS converter converts the input text segment from document server 20 to speech using the prosodic parameters received from the mood translation module 21 to create the mood associated with the text segment.

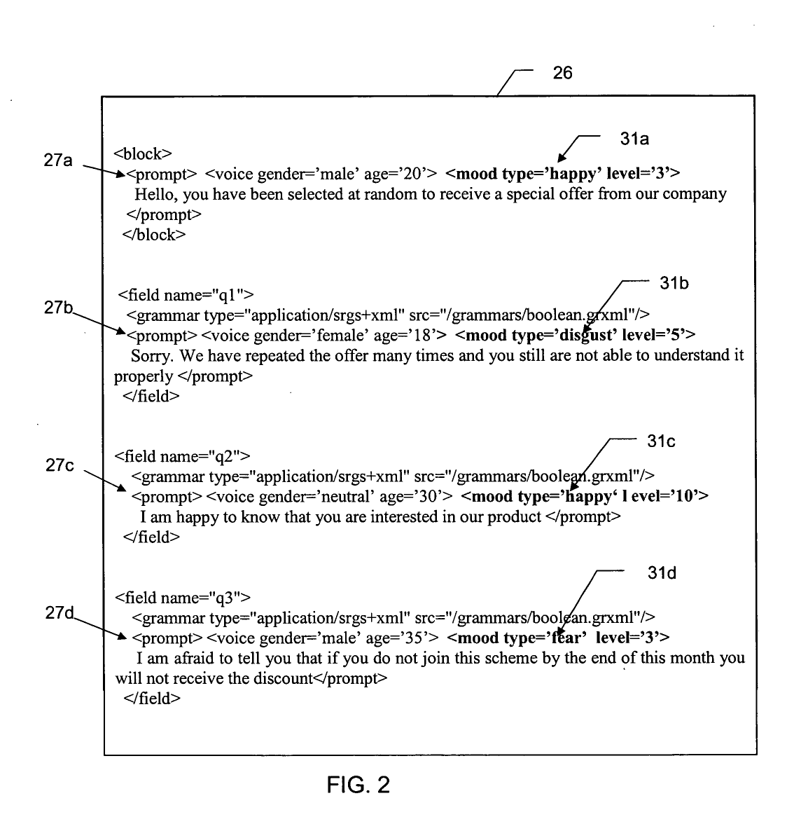

FIG. 2 illustrates a document 26 in accordance with an embodiment of the invention. The exemplary embodiment shown in FIG. 2 is in accordance with the VoiceXML synthesis mark-up language. As shown, document 26 comprises four different prompts, also known as text segments, 27a, 27b, 27c, and 27d and each has an associated mood tag 31a, 31b, 31c, and 31d, respectively. The mood tag 31 specified within a particular prompt applies to the entirety of the text within that prompt. For example, mood tag 31a applies to the text “Hello, you have been selected at random to receive a special offer from our company.” Each prompt also includes gender and age values. Prompt 27a, for example, is to be read with a 20 year old, male voice. Prompt 27b is to be read with an 18 year old, female voice, while prompts 27c and 27d are to be read with 30 year old, neutral and 35 year old, male voices, respectively.

The embodiment of FIG. 2 illustrates that mood tags are associated with the prompts in a document on a prompt-by-prompt basis. Mood tag 31a is provided as <mood type=‘happy’ level ‘3’> meaning that prompt 27a is to be read with a happy mood having intensity level 3. In a similar fashion, mood tag 31b is provided as <mood type=‘disgust’ level ‘5’> meaning that prompt 27b is to be read with a disgust mood having intensity level 5. Mood tag 31c is provided as <mood type=‘happy’ level ‘10’> meaning that prompt 27c is to be read with a happy mood having intensity level 10. Mood tag 31d is provided as <mood type=‘fear’ level ‘3’> meaning that prompt 27d is to be read with a fearful mood having intensity level 3.

Document 26 is provided by the voice portal document server 20 to the mood translation module 21. Translation module 21 reads the mood tags embedded in the document and translates each mood tag into one or more prosodic parameters having particular values to implement each such mood. The translation process may be implemented by retrieving one or more rules from the look-up table 23 associated with the specified mood tag and applying the retrieved rule(s) to modify an existing (e.g., default) set of prosodic parameters. The TTS converter 24 then converts the text to a speech signal in accordance with the prosodic parameters provided by the translation module 21. In some embodiments, the prosodic parameters to be applied by the TTS converter 24 to create the desired mood are generated by the translator module 21 and provided to the TTS converter 24. In other embodiments, the translation module 21 provides the rules to the TTS converter 24 which uses the rules to modify the default set of prosodic parameters.

Table I below illustrates 18 exemplary moods that can be implemented in accordance with an embodiment of the invention. As can be seen, the moods may comprise interrogation, contradiction, assertion, nervous, shy, happy, frustrated, threaten, regret, surprise, love, virtue, sorrow, laugh, fear, disgust, anger, and peace. Each mood parameter includes a level parameter that comprises an integer value in the range of one to ten and specifies the intensity level for the associated mood.

TABLE I
Moods

| No. | Mood | Level |
|---|---|---|
| 1 | Interrogation | 1-10 |
| 2 | Contradiction | 1-10 |
| 3 | Assertion | 1-10 |
| 4 | Nervous | 1-10 |
| 5 | Shy | 1-10 |
| 6 | Happy | 1-10 |
| 7 | Frustrated | 1-10 |
| 8 | Threaten | 1-10 |
| 9 | Regret | 1-10 |
| 10 | Surprise | 1-10 |
| 11 | Love | 1-10 |
| 12 | Virtue | 1-10 |
| 13 | Sorrow | 1-10 |
| 14 | Laugh | 1-10 |
| 15 | Fear | 1-10 |
| 16 | Disgust | 1-10 |
| 17 | Anger | 1-10 |
| 18 | Peace | 1-10 |

The rules that are used for a given mood configure the prosodic parameters in a way that the resulting speech embodies that particular mood. The configurations of the prosodic parameters to implement each of the 18 moods can be obtained by analyzing speech patterns in each of the 18 moods and computing or estimating the values of various prosodic parameters. For example, one or more samples of speech embodying a particular mood can b recorded or otherwise obtained. Applying digital signal processing techniques, the samples can be analyzed in terms of the various prosodic parameters. A suitable technique for prosody extraction is described in U.S. Pat. Publication No. 2004/0193421, incorporated herein by reference. The computed prosodic parameters for a particular mood can then be converted into one or more rules that run on CPU 22 of the mood translation module 21 and may be stored in the look-up table 23 in the mood translation module 23. The rules can be formulated in the form of percentage of variation of a baseline (default) value as explained above. For example, a particular configuration of prosodic parameters can be set to create a neutral speaking tone. The rules to implement a particular mood may comprise percentage increases or decreases of one or more prosodic parameters of the neutral speaking tone. For the parameter pitch range, a set of values comprising a contour confined to the minimum and maximum in percentage is to be stored in the look-up table 23. The TTS converter 24 converts text to speech using the rules.

By way of example, Table II below exemplifies a set of rules for modifying the prosodic parameters that may be suitable for implementing the happy, sorrow, angry, disgust, and fear moods. Unless otherwise stated herein, percentage increases or decreases are relative to the corresponding attribute relative to a default speaking tone (e.g., the neutral speaking tone). The rules exemplified below are applicable for the English language. Other languages may necessitate a different set of rules and attribute specificities.

TABLE II
Rules for Mood Implementations

| Mood | Rules for modifying prosodic parameters |
|---|---|
| Happy | Pitch (F0) - Increase baseline F0 from 20% |
| | to 50% in steps of 3% based on specified |
| | level. |
| | Pitch Range - Increase up to 100% based |
| | on specified intensity level of mood |
| | Rate - Increase words per minutes from 10% |
| | to 30% in steps of 2% based on specified |
| | level of mood. |
| | Amplitude - Increase up to 100% based on |
| | specified level of mood. |
| Sorrow | Pitch (F0) - reduce down to 10% based on |
| | level specified. |
| | Pitch Range - Start at −5%, increase to |
| | +6% |
| | Rate - 150 words per minute is average. |
| | Reduce words per minute based on level |
| | specified |
| | Amplitude - Reduce amplitude based on |
| | level specified |
| Angry | Pitch (F0) - Increase up to 40% based on |
| | level specified |
| | Pitch Range - Increase slope of pitch |
| | contour in the specified range. - Increase |
| | slope of contour |
| | Rate - 179 word per minute is average. |
| | Increase words per minute to this value |
| | Amplitude - Increase up to +6 dB |
| Disgust | Pitch (F0) - Increase to 20% in steps of 2 |
| | based on level specified |
| | Pitch Range - not modified |
| | Rate - Reduce words per minute by |
| | approximately 2 words per minute for each |
| | mood level |
| | Amplitude - reduce amplitude to −10% in |
| | decibels based on level specified. |
| Fear | Pitch (F0) - Increase from 10% to 30% in |
| | steps of 2% based on specified level. |
| | Pitch Range - Increase the slope of pitch |
| | contour |
| | Rate - reduce words per minute by 1 word |
| | per minute for each mood level |
| | Amplitude - reduce amplitude |

Table II shows that among the moods illustrated, the happy mood has the highest F0 (pitch) and the sorrow mood has the lowest F0 value. Further, speaking rate ranges from 150 words per minute for a sorrow mood to 179 for an angry one. The difference between peaks and troughs in F0 contour (“pitch range” also called the “F0 Range” is set to have the smallest range for the sorrow mood and angry mood is set to have the highest one.

Amplitude controls the volume of the speech output. The sorrow mood has a smaller value compared with the happy and anger moods. To set the amplitude for the speech output of one text segment for a specific mood, the amplitude value specified for the previous segment is modified because amplitude variation for moods is relative to the adjacent segments of the text. That is, the amplitude to be applied to a particular text segment depends on the amplitude of the prior text segment. Based on the intensity of the mood specified in the speech synthesis markup language document, values for these parameters are selected from the beginning of the allowed range to the end of the allowed range.

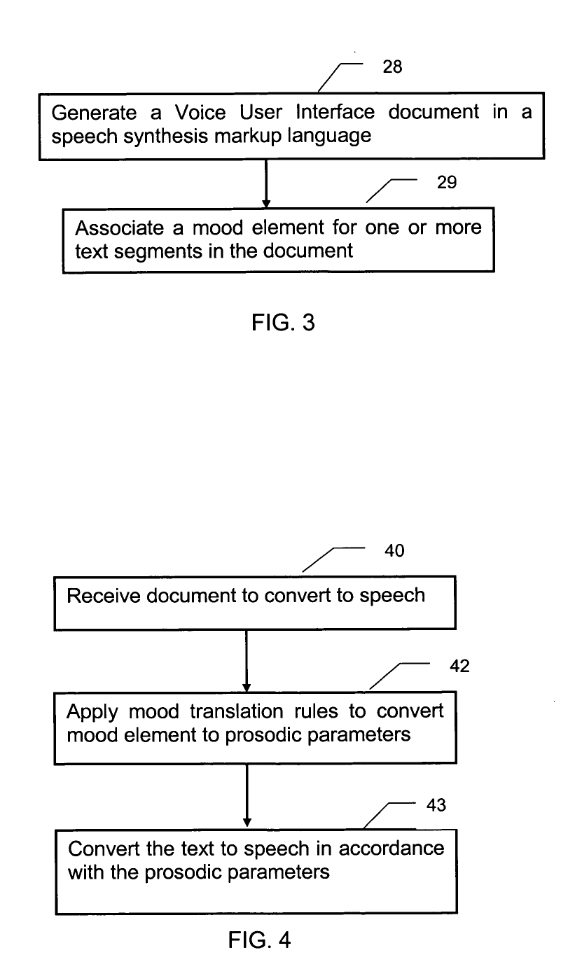

FIG. 3 shows a method embodiment related to the creation of a document with embedded mood tags. At block 28, the method comprises generating text to include in a voice user interface document that complies with a speech synthesis markup language (e.g., VoiceXML). The document may be created in the form of a file or may comprise a text stream created dynamically and not permanently stored. The function of block 28 can be performed, for example, by a person using a word processing program. In block 29, the method of FIG. 3 comprises associating a mood tag with each desired text segment. In VoiceXML, for example, text segments referred to above as “prompts” and each prompt tag (e.g., 27a and 31a in FIG. 2) controls the output of synthesized speech in terms of gender and age. The associated mood tag is embedded in a prompt that the document author desires to have read by the TTS converter 24 in a particular mood.

The method may comprise embedding more than one mood tag in the document. If multiple mood tags are used, such mood tags may be the same or different. In some embodiments, a document may have a default mood applied to all of its text unless a mood tag is otherwise imposed on certain text segments. The same mood tag may thus be associated with multiple discrete portions of text. For example, two prompts in a document may be spoken in accordance with the angry mood by associating the desired prompts with the angry mood tag. In other embodiments, different moods can be associated with different text segments.

FIG. 4 shows another method embodiment related to converting the text to speech. At block 40, the method includes receiving text to convert to speech. Some or all of the text may have an associated mood tag. The received text may be in the form of a file (e.g. a document), text stream, etc. At block 42, the method comprises converting the mood tag into the corresponding prosodic parameters using the mood translation rules stored in the mood translation module 21. At block 43, the method comprises converting text to speech in accordance with a set of prosodic parameters associated with the received text. Converting the text to speech in accordance with the prosodic parameters is performed by the TTS converter 24 making use of the prosodic parameters supplied along with the text.

Different portions of the text may have different mood tags and thus the TTS converter 24 is dynamically configurable to create different moods while reading a document. Any portion of text not designated to have a particular mood may be converted to speech in accordance with any suitable default mood.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method, comprising:
associating a mood tag with text, wherein said mood tag specifies a mood to be applied when said text is subsequently converted to an audio signal.

2. The method of claim 1 wherein associating a mood tag comprises using a mood tag that corresponds to a mood selected from a group consisting of interrogation, contradiction, assertion, nervous, shy, happy, frustrated, threaten, regret, surprise, love, virtue, sorrow, laugh, fear, disgust, anger, and peace.

3. The method of claim 1 further comprising associating a plurality of mood tags with text in a document.

4. The method of claim 1 further comprising associating a plurality of mood tags with text in a document, the plurality of mood tags not all corresponding to the same moods.

5. The method of claim 4 wherein the moods are selected from a group consisting of interrogation, contradiction, assertion, nervous, shy, happy, frustrated, threaten, regret, surprise, love, virtue, sorrow, laugh, fear, disgust, anger, and peace.

6. The method of claim 1 further comprising converting said text to audio in accordance with the mood tag.

7. A method, comprising:
receiving text having an associated mood tag; and
converting said text to speech in accordance with said associated mood tag.

8. The method of claim 7 wherein the mood tag is associated with a mood selected from a group consisting of interrogation, contradiction, assertion, nervous, shy, happy, frustrated, threaten, regret, surprise, love, virtue, sorrow, laugh, fear, disgust, anger, and peace.

9. The method of claim 7 comprising converting different portions of said text to speech in accordance with a mood tag associated with each portion.

10. The method of claim 9 wherein the mood tag associated with each portion differs from at least one other mood value.

11. The method of claim 7 wherein converting said text to speech in accordance with the mood tag comprises configuring one or more parameters associated with a speech synthesizer.

12. The method of claim 11 wherein configuring a parameter comprises configuring an parameter selected from a group consisting of pitch, pitch range, rate, and volume.

13. The method of claim 7 wherein converting said text to speech in accordance with the mood tag comprises configuring a plurality of parameters associated with a speech synthesizer.

14. The method of claim 7 wherein converting said text to speech in accordance with the mood value comprises applying a set of rules for modifying prosody.

15. The method of claim 14 wherein applying a set of rules for modifying prosody comprises applying a set of rules for modifying a prosodic parameter selected from a group consisting of pitch, pitch range, rate, and volume.

16. A system, comprising:
a document server;
a mood translator coupled to the document server; and
a text-to-speech (TTS) converter coupled to the mood translator, wherein said TTS converter converts text to a speech signal;
wherein a mood tag is embedded in the voice user interface document and said mood translator passes stored prosodic parameters to the TTS converter which produces speech signal as specified by the mood tag.

17. The system of claim 16 wherein the TTS converter provides the speech signal to be heard via a telephone.

18. The system of claim 16 wherein the mood specified by the mood tag is selected from a group consisting of interrogation, contradiction, assertion, nervous, shy, happy, frustrated, threaten, regret, surprise, love, virtue, sorrow, laugh, fear, disgust, anger, and peace.

19. The system of claim 16 wherein the TTS converter configures one or more prosodic parameters to produce the speech signal as specified by the mood tag.

20. The system of claim 16 wherein the TTS converter configures at least one of pitch, pitch range, rate, and volume to produce the speech signal as specified by the mood tag.

21. The system of claim 16 wherein the TTS converter implements a plurality of prosodic parameters in accordance with converting the text to the speech signal, and said TTS converter configures the prosodic parameters to implement the mood specified by the mood tag.

22. A system, comprising:
means for converting text to a speech signal in accordance with a mood tag embedded in the text, said mood tag specifying a mood;
means for producing sound based on the speech signal;

23. The system of claim 22 wherein the mood specified by the mood tag is selected from a group consisting of interrogation, contradiction, assertion, nervous, shy, happy, frustrated, threaten, regret, surprise, love, virtue, sorrow, laugh, fear, disgust, anger, and peace.

24. The system of claim 2 wherein the means for converting text to a speech signal is also for configuring a prosodic parameter to be applied to said text.

25. A mood translation module, comprising
a CPU;
software running on the CPU that causes the CPU to modify a prosodic parameter to generate a speech signal in accordance with a mood specified for a text segment.

26. The mood translation module of claim 25 wherein the mood is selected from the group consisting of interrogation, contradiction, assertion, nervous, shy, happy, frustrated, threaten, regret, surprise, love, virtue, sorrow, laugh, fear, disgust, anger, and peace.
